(19) United States
(12) Patent Application Publication
(10) Pub. No.: US 2022/0294895 A1
(43) Pub. Date: Sep. 15, 2022

(54) ELECTRONIC DEVICE FOR GENERATING CONTENTS

(71) Applicant: Samsung Electronics Co., Ltd., Gyeonggi-do (KR)

(72) Inventors: Yoonjoo NA, Gyeonggi-do (KR); Sungwook BYUN, Gyeonggi-do (KR)

(21) Appl. No.: 17/426,745

(22) PCT Filed: Jan. 6, 2020
(86) PCT No.: PCT/KR2020/000163

§ 371 Date: Jan. 18, 2022

(30) Foreign Application Priority Data
Jan. 30, 2019 (KR) 10-2019-0012271

(51) Int. Cl. H04M 1/72469; H04M 1/72463; G10L 13/08; H04M 1/72433

(52) U.S. Cl. CPC H04M 1/72469; H04M 1/724634; G10L 13/08; H04M 1/72433

(57) ABSTRACT

An electronic device is disclosed, including a display, an input circuit, a wireless communication circuit, a processor operatively connected with the display and the wireless communication circuit, a memory operatively connected with the processor, wherein the memory stores a plurality of applications and instructions that are executable by the processor to cause the electronic device to: output, on the display, an execution screen of a first application capable of receiving a user input, receive, through the input circuit, the user input through the execution screen, extract a first text from the received user input, transmit, using the wireless communication circuit, the extracted text to an external server, and receive, from the external server, a file combining the extracted text, vocalized audio corresponding to the extracted text, and a melody.

### TECHNICAL FIELD

The present disclosure relates to generating content in an electronic device, and, more particularly, to short messages combining extracted text, vocal data, and stored melodies.

### BACKGROUND

As electronic devices (e.g., smartphones) have grown in popularity, available applications executable by these devices have also diversified. For example, a user may communicate with another user using a chat application, may share his or her opinion or daily life with other users by means of an SNS, etc.

### SUMMARY

However, when providing the same user interface to users, applications may not provide content in which aesthetic preferences, tastes or sensitivity of each user is properly reflected. For example, if a chat application provides a user with visual effect-driven emoticons, there may be limitations in the ability to deliver an emoticon reflecting a present emotional state of the user.

Embodiments disclosed in the disclosure are to provide an electronic device for addressing the above-mentioned problems or problems raised in the disclosure.

In accordance with an aspect of the disclosure, an electronic device is provided. The electronic device may include a display, an input circuit, a wireless communication circuit, a processor operatively connected with the display and the wireless communication circuit, a memory operatively connected with the processor, wherein the memory stores a plurality of applications and instructions that are executable by the processor to cause the electronic device to: output, on the display, an execution screen of a first application capable of receiving a user input, receive, through the input circuit, the user input through the execution screen, extract a first text from the received user input, transmit, using the wireless communication circuit, the extracted text to an external server, and receive, from the external server, a file combining the extracted text, vocalized audio corresponding to the extracted text, and a melody.

In accordance with another aspect of the disclosure, an electronic device is provided. The electronic device may include a display, a wireless communication circuit, an input circuit including a microphone, a processor operatively connected to the display, the communication circuit, and the microphone, and a memory operatively connected with the processor, wherein the memory stores a plurality of audio data, a plurality of melodies, and instructions, the instructions executable by the processor to cause the electronic device to: output an execution screen of a first application capable of receiving a user input, receive a vocal input through the microphone, extract a first text from the received vocal input, combine a portion of the vocal input corresponding to the extracted first text with the extracted first text, display a plurality of selectable templates, each template representing a type of melody, on the execution screen, receive a second user input selecting at least one template from among the plurality of selectable templates, and generate a file combining the extracted text, the received vocal input, and the melody.

In accordance with another aspect of the disclosure, a server is provided. The server may include at least one memory configured to store a plurality of vocal data and a plurality of melodies, a communication circuit, and a processor operatively connected with the memory and the communication circuit, wherein the processor is configured to: receive a transmission of text and information indicating a template from an external electronic device via the communication circuit, retrieve vocal data corresponding to the received text from among the plurality of vocal data, and combine the retrieved vocal data with the received text, retrieve a melody corresponding to the indicated template from among the plurality of melodies, and combine the retrieved melody with the text, and generate a file in which the received text, the vocal data, and the melody are combined, and transmit the generated file to the external electronic device.

According to embodiments disclosed in the disclosure, various pieces of content may be generated according to an intention of the user and/or to represent user's own sensitivity.

In addition, various effects ascertained directly or indirectly through the disclosure may be provided.

### BRIEF DESCRIPTION OF THE DRAWINGS

FIG. 1 is a block diagram illustrating an electronic device in a network environment, according to certain embodiments;

FIG. 2 is a block diagram illustrating a program according to certain embodiments;

FIG. 3 illustrates an operation sequence of an electronic device according to an embodiment;

FIG. 4 illustrates an operational flowchart of an electronic device according to an embodiment;

FIG. 5 illustrates an operation environment of an electronic device according to an embodiment; and

FIG. 6 illustrates an operation environment of an electronic device according to another embodiment.

### DETAILED DESCRIPTION

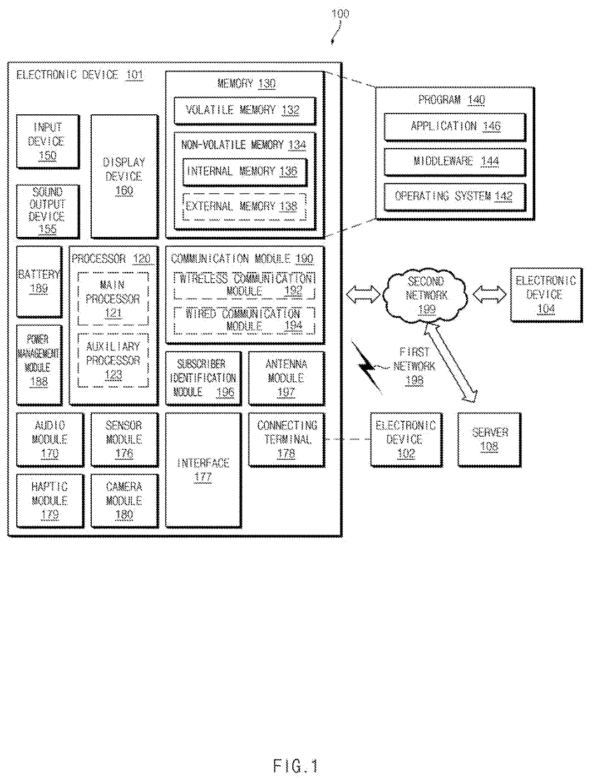

FIG. 1 is a block diagram illustrating an electronic device 101 in a network environment 100 according to certain embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element implemented using a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

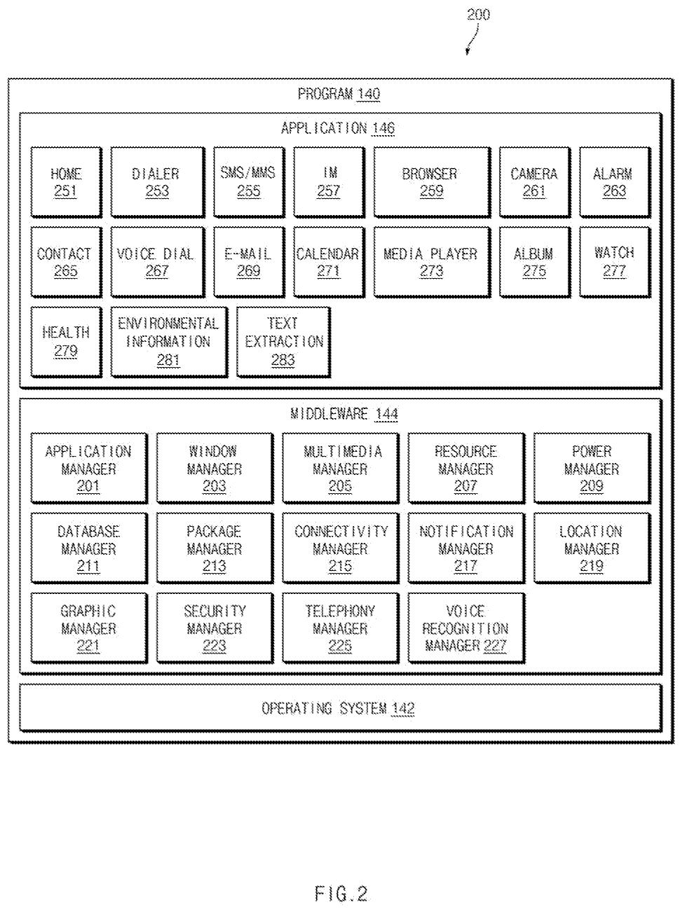

FIG. 2 is a block diagram 200 illustrating a program according to certain embodiments.

According to an embodiment, a program 140 may include an operating system 142 for controlling one or more resources of an electronic device 101, middleware 144, and an application 146 executable by the operating system 142. The operating system 142 may include, for example, Android™, iOS™, Windows™, Symbian™, Tizen™, or Bada™. For example, at least a portion of the program 140 may be preloaded on the electronic device 101 when the electronic device 101 is manufactured or may be downloaded and updated from an external electronic device (e.g., an electronic device 102 or 104 or a server 108) when the electronic device 101 is used by a user.

The operating system 142 may control to manage (e.g., assign or collect) one or more system resources (e.g., a process, a memory, or a power supply) of the electronic device 101. Additionally or alternatively, the operating system 142 may include one or more driver programs for driving another hardware device of the electronic device 101, for example, an input device 150, a sound output device 155, a display device 160, an audio module 170, a sensor module 176, an interface 177, a haptic module 179, a camera module 180, a power management module 188, a battery 189, a communication module 190, a subscriber identification module 196, or an antenna module 197.

The middleware 144 may provide the application 146 with various functions such that functions or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201 may manage, for example, a life cycle of the application 146. The window manager 203 may manage, for example, one or more graphic user interface (GUI) resources used on a screen. The multimedia manager 205 may identify, for example, one or more formats utilized for playing media files and may encode or decode a corresponding media file among the media files using a codec suitable for the format selected among the one or more formats. The resource manager 207 may manage, for example, a source code of the application 146 or a memory space of a memory 130. The power manager 209 may manage, for example, capacity, temperature, or power of the battery 189 and may determine or provide related information utilized for an operation of the electronic device 101 using the corresponding information among the capacity, the temperature, or the power of the battery 189. According to an embodiment, the power manager 209 may interwork with a basic input/output system (BIOS) (not shown) of the electronic device 101.

The database manager 211 may generate, search, or modify, for example, a database to be used by the application 146. The package manager 213 may manage to install or update, for example, an application distributed in the form of a package file. The connectivity manager 215 may manage, for example, a wireless connection or a direct connection between the electronic device 101 and the external electronic device. The notification manager 217 may provide, for example, a function for notifying a user that a specified event (e.g., an incoming call, a message, or an alarm) occurs. The location manager 219 may manage, for example, location information of the electronic device 101. The graphic manager 221 may manage, for example, one or more graphic effects to be provided to the user or may manage a UI associated with the graphic effects.

The security manager 223 may provide, for example, system security or user authentication. The telephony manager 225 may manage, for example, a voice or video call function provided by the electronic device 101. The voice recognition manager 227 may transmit, for example, voice data of the user to the server 108 and may receive a command corresponding to a function to be performed in the electronic device 101 based at least in part on the voice data or text data converted based at least in part on the voice data from the server 108. According to an embodiment, the middleware 144 may dynamically fail to include some of the existing components or may further include new components. According to an embodiment, at least a portion of the middleware 144 may be included as a portion of the operating system 142 or may be implemented as separate software different from the operating system 142.

The application 146 may include, for example, a home application 251, a dialer application 253, an SMS/MMS application 255, an instant message (IM) application 257, a browser application 259, a camera application 261, an alarm application 263, a contact application 265, a voice recognition application 267, an e-mail application 269, a calendar application 271, a media player application 273, an album application 275, a watch application 277, a health application 279 (e.g., an application for measuring biometric information such as an exercise quantity or blood sugar), an environmental information application 281 (e.g., an application for measuring information about barometric pressure, humidity, or temperature), or a text extraction application 283. The text extraction application 283 may extract text from the user input to the electronic device. For example, the text extraction application 283 may extract text from the user voice input through the microphone.

According to an embodiment, the application 146 may further include an information exchanging application (not shown) capable of supporting information exchange between the electronic device 101 and the external electronic device. The information exchanging application may include, for example, a notification relay application configured to transmit specified information (e.g., a call, a message, or an alarm) to the external electronic device or a device management application configured to manage the external electronic device. For example, the notification relay application may transmit notification information corresponding to a specified event (e.g., mail reception) which occurs in another application (e.g., the e-mail application 269) of the electronic device 101 to the external electronic device.

Additionally or alternatively, the notification relay application may receive notification information from the external electronic device and may provide a user of the electronic device 101 with the received notification information.

The device management application may control, for example, a power (e.g., turn-on/turn-off of the power) of the external electronic device which communicates with the electronic device 101 and a power of each of some components (e.g., the display device 160 or the camera module 180) of the electronic device 101 or may control a function (e.g., brightness, resolution, or focus) of each of some components (e.g., the display device 160 or the camera module 180) the electronic device 101. Additionally or alternatively, the device management application may support the installation, deletion, or update of an application running on the external electronic device.

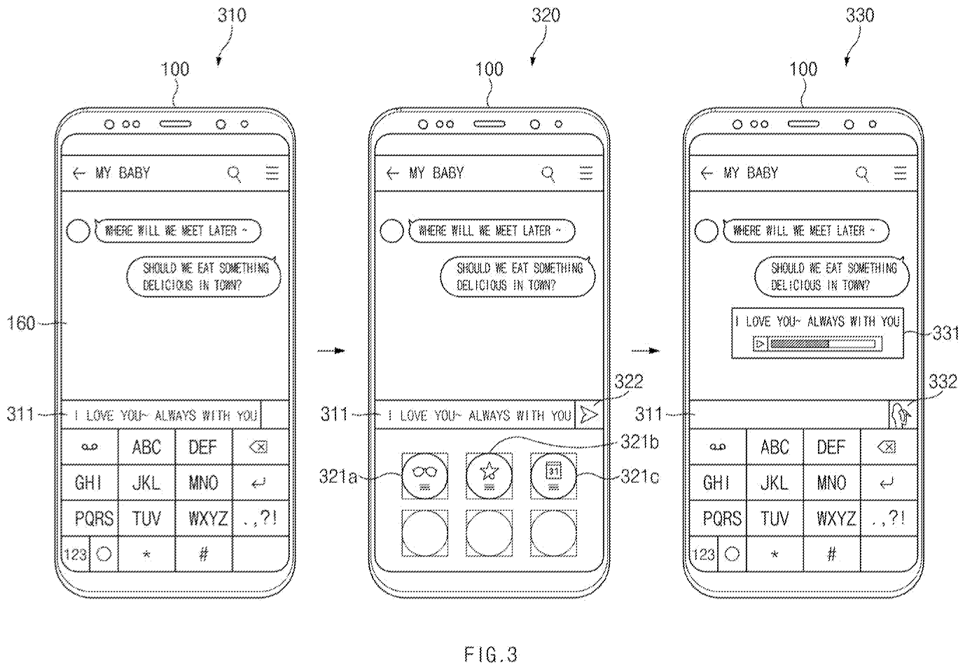

FIG. 3 illustrates an example operation sequence of an electronic device according to an embodiment. In the disclosure, the contents described in FIGS. 1 and 2 are also applicable to the components having the same reference numerals as the components included in the electronic device 101 shown in FIG. 1 and the program 140 shown in FIG. 2.

Referring to FIG. 3, in a first user interface 310, a processor 120 may output a “running screen” (i.e., an execution screen) of a first application on a display 160. The first application may be an application capable of receiving a user input, which may include, for example, a messaging application, KakaoTalk, Twitter, Facebook, Instagram, Bixby, or a memo pad, etc.

According to an embodiment, in the first interface screen 310, the processor 120 may execute a second application capable of extracting text from a user input. For example, the second application may be the same or different from the first application, and may be an application run in an external server. The second application may extract text from a user input (e.g., a vocal input) input via the input device 150 or may extract text from a user input through an input window 311. For example, as shown in 310 of FIG. 3, when a user enters “I love you—always with you” through the input window 311, the second application may extract the text “I love you—always with you”.

In the second user interface screen 320, the processor 120 may output selectable templates 321a, 321b, and 321c. The templates 321a, 321b, and 321c may include icons allowing the user to select a type of a melody. For example, the templates 321a, 321b, and 321c may include the first template 321a, the second template 321b, and the third template 321c. The user may select any one of the first to third templates 321a to 321c.

According to an embodiment, the processor 120 may transmit the text extracted via the first user interface screen 310 and the template information selected via the second user interface screen 320 to the external server. For example, when the user contacts a send icon 322 (e.g., via touch screen), the processor 120 may transmit the extracted text and the template information to the external server.

The external server may transmit a file 331 in which a vocalized input (e.g., a “vocal”; or also referred to as “vocal data”) and a melody are combined with the extracted text to the electronic device 101. The “vocal” may refer to a voice of a person corresponding to the extracted text. For example, when the user vocalizes “I love you—always with you” and when the text “I love you—always with you” is extracted through the corresponding utterance, a voice of the person which utters the corresponding vocal may be combined with the extracted text. Furthermore, a melody corresponding to the selected template may be combined with the extracted text. For example, when the first template 321a is selected (e.g., a ballad), a ballad-type melody may be combined with the extracted text.

In the third user interface screen 330, the processor 120 may receive the file 331 in which the extracted text, the vocal corresponding to the extracted text, and the selected melody are combined from the external server. When the file 331 is received, the processor 120 may output the file 331 on the display 160.

According to an embodiment, the processor 120 may play the file 331. For example, when the user touches a play icon 332, the processor 120 may initiate playback, including output of the extracted text on the display 160 and output of the vocal and the melody via a sound output device 155. According to an embodiment of the disclosure, the electronic device 101 may extract the text from the user input and may transmit the extracted text to the external server, thus generating various pieces of content according to an intention of the user.

According to an embodiment, the processor 120 may transmit the file 331 to another electronic device. For example, in the third user interface 330, the processor 120 may output the send icon 322 rather than the play icon 332 on the display 160. When the user touches the send icon 322, the processor 120 may transmit the file 331 to another electronic device. A user of the other electronic device may receive and playback the file 331. According to an embodiment of the disclosure, the electronic device 101 may extract the text from the user input and may transmit the file 331 in which the vocal and the melody are combined with the extracted text to another electronic device, thus effectively communicating an emotion or state of the user to another user.

According to an embodiment of the disclosure, the electronic device 101 may perform the above-mentioned operations without the external server. For example, the electronic device 101 may extract text from a user input. Furthermore, the electronic device 101 may output the plurality of templates 321a, 321b, and 321c on the display 160, such that the user may select the melody. When the user selects the melody by means of the plurality of templates 321a, 321b, and 321c, the electronic device 101 may generate the file 331 in which the vocal and the melody are combined with the extracted text. The generated file 331 may be stored in a memory 130. The user may play the file 331 or may transmit the file 331 to another user.

In the disclosure, the contents described in FIGS. 1 to 3 are also applicable to the components having the same reference numerals as the components included in the electronic device 101 shown in FIGS. 1 to 3.

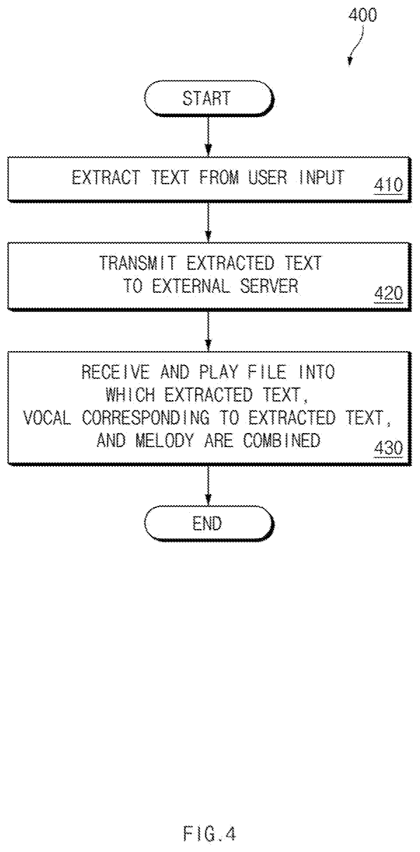

FIG. 4 illustrates an operational flowchart 400 of an electronic device according to an embodiment.

Referring to FIG. 4, in operation 410, an electronic device 101 may receive a user input and may extract text from the received user input. For example, when a user enters text while Instagram is running, the electronic device 101 may extract the entered text. For another example, when the user inputs an utterance while Bixby is running, the electronic device 101 may extract text from the utterance. For another example, when the user captures an image of a sign using a camera, the electronic device 101 may extract text depicted in the sign.

In operation 420, the electronic device 101 may transmit the extracted text to an external server. The electronic device 101 may output selectable templates on a display 160. The user may select any one of the templates. The electronic device 101 may transmit information of the selected template together with the extracted text to the external server. According to an embodiment, a melody corresponding to the selected template may be included in the information of the selected template.

The external server may transmit a file in which the vocal and the melody are combined with the extracted text to the electronic device 101. The vocal may refer to a voice playback of a person that corresponds to the extracted text. For example, when the user captures the sign “AA hair salon” by means of a camera, a voice uttering “AA hair salon” may be combined with text extracted from the sign. Furthermore, a melody corresponding to the selected template may be combined with the extracted text.

In operation 430, the electronic device 101 may receive a file in which the extracted text, the vocal corresponding to the extracted text, and the melody are combined, from the external server. When the file is received, the electronic device 101 may transmit the file to another electronic device, and/or may execute playback of the file upon receiving a corresponding command.

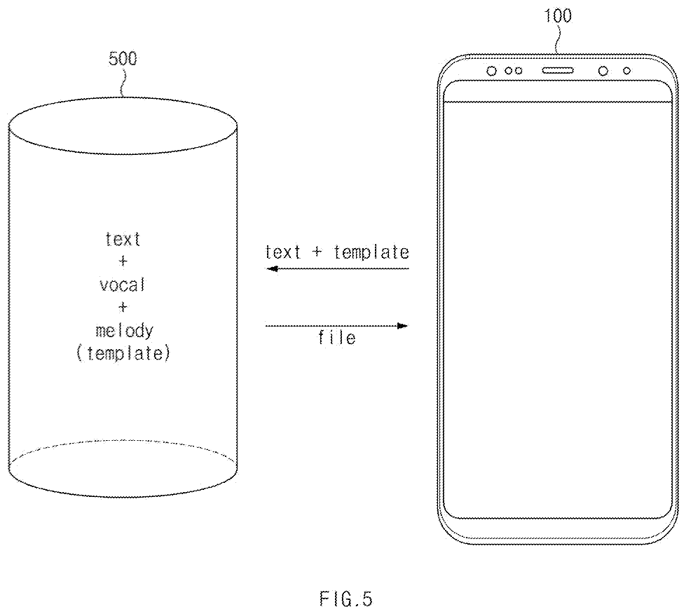

FIG. 5 illustrates an operation environment of an electronic device according to an embodiment. FIG. 5 is a drawing illustrating in detail operations of the electronic device 101 and the external server 500 according to an embodiment.

Referring to FIG. 5, the electronic device 101 may receive a user input and may extract text from the received user input. For example, when a user enters specific text in a memo pad, the electronic device 101 may extract the text. Furthermore, the electronic device 101 may output a plurality of templates on a display 160, such that the user may select a specific melody. The template selected by the user may be transmitted together with the extracted text to the external server 500.

According to an embodiment, the electronic device 101 may transmit the extracted text and the selected template to the external server 500. The operation of transmitting the extracted text and the selected template to the external server 500 may be performed without a separate trigger in some embodiments, and/or may be transmitted in response to a user input in other embodiments.

The external server 500 may combine a vocal and a melody with the extracted text. For example, the external server 500 may store several vocals and melodies. When the text and the template are transmitted from the electronic device 101, the external server 500 may combine a vocal corresponding to the text from among the vocals stored in the external server 500. Furthermore, the external server 500 may combine a melody corresponding to the selected template with text. For example, when a third template 321c between a first template 321a and the third template 321c shown in FIG. 3 is selected, the external server 500 may combine a dance melody (e.g., as corresponding to the third template 321c) with text.

According to an embodiment, the external server 500 may transmit a file into which the text, the vocal, and the melody are combined to the electronic device 101. When the file is received, the electronic device 101 may transmit the file to another electronic device or may play the file. When the file is transmitted to the other electronic device, a user of the other electronic device may execute playback of the file.

Although not illustrated in FIG. 5, when a lock state is imposed on the device, it may be that upon release of the lock state, the electronic device 101 may initiate playback the file received from the external server 500. For example, when the user releases the lock state by means of biometric authentication (e.g., fingerprint authentication, iris authentication, face authentication, speech authentication, or blood vessel authentication), a password, and/or pattern authentication in the lock state, the electronic device 101 may play the file received from the external server 500. As another embodiment, the electronic device 101 may store the file in a memory 130 and may play the stored file in response to a user input.

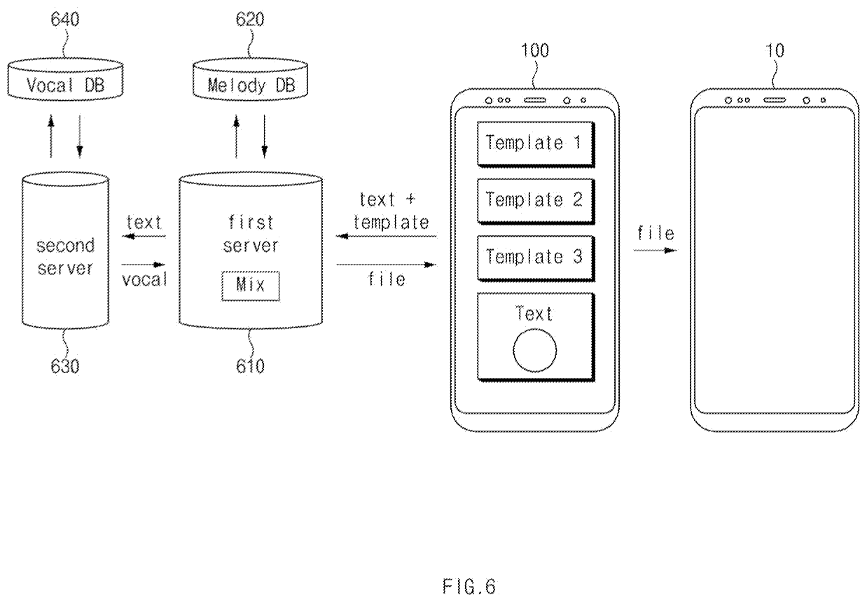

FIG. 6 illustrates an operation environment of an electronic device according to another embodiment. FIG. 6 is a drawing illustrating in detail operations of an electronic device 101 and external servers 610 and 630 according to another embodiment.

Referring to FIG. 6, the electronic device 101 may receive a user input and may extract text from the received user input. Furthermore, the electronic device 101 may output a plurality of templates on a display 160, such that a user may select a specific melody. The user may select any one of the plurality of templates.

According to an embodiment, the electronic device 101 may transmit the extracted text and the selected template to the first server 610. The first server 610 may select a melody based on the template. For example, the melody DB 620 may store several melodies. The first server 610 may select a melody corresponding to the template among the melodies stored in the separate melody DB 620.

According to an embodiment, the first server 610 may transmit the extracted text to the second server 630. The second server 630 may select a vocal corresponding to the text from the separate vocal DB 640. For example, the vocal DB 640 may store several vocals. The second server 630 may select and transmit the vocal corresponding to the text among the vocals stored in the vocal DB 640 to the first server 610.

The first server 610 may combine the vocal transmitted from the second server 630 and the melody selected from the melody DB 620 with the text. The first server 610 may transmit a file into which the text, the vocal corresponding to the text, and the melody are combined to the electronic device 101.

When the file is received, the electronic device 101 may transmit the file to another electronic device 10 or may play the file. When the file is transmitted to the other electronic device, a user of the other electronic device 10 may play and appreciate the file.

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Certain embodiments of the present disclosure may be implemented as software (e.g., a program) including one or more instructions stored in a storage medium (e.g., an internal memory or an external memory) 138 readable by a machine (e.g., an electronic device).

For example, a processor (e.g., a processor 120) of a machine (e.g., an electronic device 101) may invoke at least one instruction among one or more stored instructions from the storage medium and may execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. The term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStoreTM), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
a display;
an input circuit;
a wireless communication circuit;
a processor operatively connected with the display and the wireless communication circuit;
a memory operatively connected with the processor,
wherein the memory stores a plurality of applications and stsarec instructions that are executable by the processor to cause the electronic device to:
output, on the display, an execution screen of a first application capable of receiving a user input;
receive, through the input circuit, the user input through the execution screen;
extract a first text from the received user input;
transmit, using the wireless communication circuit, the extracted text to an external server; and
receive, from the external server, a file combining the extracted text, a vocalized audio corresponding to the extracted text, and a melody.

2. The electronic device of claim 1, wherein the instructions cause the processor to:
display, on the display, a plurality of selectable templates, each template representing a type of melody;
receive a second user input selecting at least one temnlate from among the plurality of selectable templatess; and
transmit, using the wireless communication circuit, information identifying the selected at least one template to the external server.

3. The electronic device of claim 2, wherein the information identifying the selected at least one template includes at least one type of melody corresponding to the selected at least one template.

4. The electronic device of claim 1, wherein the instructions cause the processor to display, on the display, an icon selectable to initiate playback of the received file.

5. The electronic device of claim 4, further comprising:
a speaker configured to output the vocalized audio and the melody,
wherein the instructions cause the processor to:
output the vocalized audio and the melody through the speaker, in response to detecting a selection of the icon.

6. The electronic device of claim 1, wherein the instructions cause the processor to:
store the received file in the memory; and
transmit, via the wireless communication circuit the stored file to an external electronic device.

7. The electronic device of claim 1, wherein the instructions cause the processor to:
execute screen lock on the execution screen;
when detecting a release of the screen lock, initiating playback of the received file, when a screen lock state of the execution screen is released.

8. The electronic device of claim 1, further comprising:
a camera configured to capture image data,
wherein the instructions cause the processor to:
capture an image using the camera; and
extract a second text from the captured image.

9. The electronic device of claim 1,
wherein the input circuit includes a microphone,
wherein the user input includes a vocal input received through the microphone, and
wherein the text is extracted from the received vocal input.

10. An electronic device, comprising:
a display;
a wireless communication circuit;
an input circuit including a microphone;
a processor operatively connected to the display, the communication circuit, and the microphone; and
a memory operatively connected with the processor,
wherein the memory stores a plurality of audio data, a plurality of melodies, and instructions, the instructions executable by the processor to cause the electronic device to:
output an execution screen of a first application capable of receiving a user input;
receive a vocal input through the microphone;
extract a first text from the received vocal input;
combine a portion of the vocal input corresponding to the extracted first text with the extracted first text;
display a plurality of selectable templates, each template representing a type of melody, on the execution screen;
receive a second user input selecting at least one template from among the plurality of selectable templates; and
generate a file combining the extracted text, the received vocal input and the melody.

11. (canceled)

12. The electronic device of claim 10, wherein the instructions cause the processor to:
extract a second text from atea user input received through the display.

13. The electronic device of claim 10, further comprising:
a camera configured to capture image data,
wherein the instructions cause the processor to;
capture an image using the camera; and
extract a second text from the captured image.

14. A server, comprising:
at least one memory configured to store a plurality of vocal data and a plurality of melodies;
a communication circuit; and
a processor operatively connected with the memory and the communication circuit,
wherein the processor is configured to:
receive a transmission of text and information indicating a template from an external electronic device via the communication circuit;
retrieve vocal data corresponding to the received text from among the plurality of vocal data, and combine the retrieved vocal data with the received text;
retrieve a melody corresponding to the indicated template from among the plurality of melodies, and combine the retrieved melody with the text; and
generate a file in which the received text, the vocal data, and the melody are combined, and transmit the generated file to the external electronic device.

5. The electronic device of claim 14, wherein the memory includes a first database storing the plurality of melodies and a second database storing the plurality of vocal data.
